(19) United States
(12) Patent Application Publication
(10) Pub. No.: US 2023/0312429 A1
(43) Pub. Date: Oct. 5, 2023

(54) GRANULES OF POLYHALITE AND PHOSPHOGYPSUM AND A PROCESS FOR THE PRODUCTION THEREOF

(71) Applicant: ICL EUROPE COOPERATIEF U.A., Amsterdam (NL)

(72) Inventors: Khalil ABU-RABEAH, Beer Sheva (IL); Marina DAKOV, Arad (IL)

(21) Appl. No.: 18/019,807

(22) PCT Filed: Aug. 8, 2021
(86) PCT No.: PCT/IL2021/050962

§ 371 Date: Feb. 5, 2023

Related U.S. Application Data
(60) Provisional application No. 63/065,263, filed on Aug. 13, 2020.

(51) Int. Cl. C05G 1/00; C05G 5/12; C05G 5/40; C05G 5/30; C05D 1/00; C05B 3/00

(52) U.S. Cl. CPC C05G 1/00; C05B 3/00; C05D 1/005; C05G 5/12; C05G 5/30; C05G 5/40

(57) ABSTRACT

There is provided herein a granule comprising Polyhalite and phosphogypsum, in a ratio of between 40:60 to 60:40, respectively.

### FIELD OF THE INVENTION

The present invention relates to the field of composite fertilizers, specifically to production of a fertilizer containing polyhalite and phosphogypsum.

### BACKGROUND OF THE INVENTION

To grow properly, plants need nutrients (nitrogen, potassium, calcium, zinc, magnesium, iron, manganese, etc.) which normally can be found in the soil. Sometimes fertilizers are needed to achieve a desired plant growth as these can enhance the growth of plants.

This growth of plants is met in two ways, the traditional one being additives that provide nutrients. The second mode by which some fertilizers act is to enhance the effectiveness of the soil by modifying its water retention and aeration. Fertilizers typically provide, in varying proportions, three main macronutrients:
Nitrogen (N): leaf growth;
Phosphorus (P): Development of roots, flowers, seeds, fruit;
Potassium (K): Strong stem growth, movement of water in plants, promotion of flowering and fruiting;
three secondary macronutrients: calcium (Ca), magnesium (Mg), and Sulphur (S); micronutrients: copper (Cu), iron (Fe), manganese (Mn), molybdenum (Mo), zinc (Zn), boron (B), and of occasional significance there are silicon (Si), cobalt (Co), and vanadium (V) plus rare mineral catalysts. The most reliable and effective way to make the availability of nutrients coincide with plant requirements is by controlling their release into the soil solution, using slow release or controlled release fertilizers.

Both slow release fertilizers (SRF) and controlled release fertilizers (CRF) supply nutrients gradually. Yet, slow release fertilizers and controlled release fertilizers differ in many ways: The technology they use, the release mechanism, longevity, release controlling factors and more.

Solid fertilizers include granules, prills, crystals and powders. A prilled fertilizer is a type of granular fertilizer that is nearly spherical made by solidifying free-falling droplets in air or a fluid medium. Most controlled-release fertilizers (CRFs) used in commercial nurseries are prilled fertilizers that have been coated with sulfur or a polymer. These products have been developed to allow a slow release of nutrients into the root zone throughout crop development.

Polyhalite is an evaporite mineral, a hydrated sulfate of potassium, calcium and magnesium with formula: K₂Ca2Mg(SO₄)₄ 2H₂O. Polyhalite is used as a fertilizer since it contains four important nutrients and is low in chloride:
48% SO₃ as sulfate
14% K₂O
6% MgO
17% CaO

Nitrogen is essential component for the plant. N containing fertilizers like Urea, ammonium nitrate, ammonium sulphate calcium nitrate and Magnesium nitrate are useful for the plant’s growth.

Urea, also known as carbamide, is an organic compound with chemical formula CO(NH₂)₂. This amide has two -NH₂ groups joined by a carbonyl (C=O) functional group.

Polyhalite and urea, although both useful for the proper growth of a plant are practically un-mixable due to urea is considered a ductile material, and polyhalite is a mined non-ductile substance. From a chemical point of view it is extremely difficult of cause the adherence of these two substances without using shear force as these are both solids.

Phosphogypsum is a waste by-product from the processing of phosphate rock in plants producing phosphoric acid and phosphate fertilizers, such as superphosphate.

Annual world production of phosphogypsum is estimated to be ~300 Mt (Yang et al., 2009). This by-product is contaminated by various impurities, both chemical and radioactive, and is usually stockpiled within special areas. The problem of contaminated phosphogypsum has already become an international ecological problem. For example, a huge amount of phospho-gypsum has accumulated in Florida (more than 1 billion (!) tons), in Europe (where the contaminated phosphogypsum is discharged into the River Rhine close to the North Sea), in Canada, Morocco, Togo, India, China, Korea, Israel, Jordan, Syria, Russia, and other parts of the world.

Phosphogypsum is contaminated by chemical and radioactive materials and, therefore, in the world is mostly dumped in stockpiled in controlled areas and only about 15% is recycled.

### SUMMARY OF THE INVENTION

According to some demonstrative embodiments, there is provided herein a granule comprising Polyhalite and phosphogypsum, in a ratio of between 40:60 to 60:40, respectively.

According to some demonstrative embodiments the ratio may be 50:50. According to some demonstrative embodiments the granule may further comprise a binder.

According to some demonstrative embodiments, the granule may further comprise at least one coating layer.

According to some embodiments, there is provided herein a method of producing the fertilizer granule disclosed herein, comprising mixing Polyhalite with phospogypsum in a ratio of 50:50 for 1-10 minutes to yield a mixture; transferring said mixture to a rotating drum for 1-10 minutes to yield granules; and drying said granules.

According to some demonstrative embodiments, the method may further comprise adding one or more inorganic materials to neutralize any acidic residues formed in the process.

According to some demonstrative embodiments, the inorganic materials may be selected from a group including phosphate rock or Calcium carbonate or a combination thereof.

### DETAILED DESCRIPTION OF THE INVENTION

According to some demonstrative embodiments, there is provided herein a granule comprising Polyhalite and phosphogypsum, in a ratio of between 40:60 to 60:40, respectively.

According to some demonstrative embodiments the ratio may be 50:50. According to some demonstrative embodiments the granule may further comprise a binder.

According to some demonstrative embodiments, the granule may further comprise carbonate salts like calcium carbonate, magnesium carbonate dolomite,e.g., to neutralize the acidic character of the phosphogypsum. According to some demonstrative embodiments, combining Phosphogypsum with polyhalite may offer a solution to the environmental problem. In addition, according to some demonstrative embodiments utilizing phosphogypsum as a fertilizer may add more nutrients to the plant, like K₂O,CaO MgO, and/or S.

Polyhalite is an evaporite mineral, a hydrated sulfate of potassium, calcium and magnesium with formula: K₂SO₄ MgSO₄ 2CaSO₄ ·2H₂O. Polyhalite is used as a fertilizer since it contains four important nutrients K₂O, CaO MgO, S and is low in chloride.

Phosphogypsum is a by production off the reaction between sulfuric acid and phosphate rock according to the following reaction:

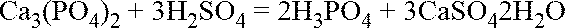

However, according to some demonstrative embodiments, the fertilizer matrix, i.e., the combination of phosphogypsum with Polyhalite may increase the sulphate value of the fertilizer.

According to some demonstrative embodiments, in the mixture the ratio of the phosphogypsum and polyhalite 60:40 to 40:60, respectively, preferably 50:50.

According to some demonstrative embodiments, the granule of the present invention may optionally include a binder, for example in a concentration between 1-5% w/w.

The binder may include but not limited : for example, organic or inorganic binders, such as, starch, bentonite, sodium silicate, lignosulfonates, molasses, hydrated lime, bitumen, Portland cement, clay, acids, cellulose gum, sucrose, water, water glass, cements, Fly Ash, Potassium and Sodium Silicate, MgO, CaO, Alganite, Geo-polymers, oils and waxesand the like, or a combination thereof.

Preferably, the binder may be water, fly ash, silicate lignosulphonate or a combination thereof.

According to some embodiments, there is provided herein a method of producing the fertilizer granule disclosed herein, comprising mixing Polyhalite with phospogypsum in a ratio of 50:50 for 1-10 minutes to yield a mixture; transferring said mixture to a rotating drum for 1-10 minutes to yield granules; and drying said granules.

According to some demonstrative embodiments, the method may further comprise adding one or more inorganic materials to neutralize any acidic residues formed in the process.

According to some demonstrative embodiments, the inorganic materials may be selected from a group including phosphate rock or Calcium carbonate or a combination thereof.

### Example-1

1500 grams of polyhalite was mixed with 1500 grams of phosphogypsum for 4 minutes to yield a mixture. The mixture was transferred to a rotating drum 25 rpm for an additional 4 minutes to yield granules.

The granules were then dried.
The granules PSD 2-4 mm
Abrasion -12 mesh 16%
Humidity content 8%.
Strength 1.9 Kg/granule

While the invention has been described with respect to a limited number of embodiments, it will be appreciated that many variations, modifications and other applications of the invention may be made.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination. It will also be appreciated by persons skilled in the art that the present invention is not limited by what has been particularly shown and described hereinabove.

1. A granule comprising Polyhalite and phosphogypsum, in a ratio of between 40:60 to 60:40, respectively.

2. The granule of claim 1, wherein said ratio is 50:50.

3. The granule of claim 1, further comprising a binder.

4. The granule of claim 1, further comprising at least one coating layer.

5. A method of producing the fertilizer of claim 1, comprising
Mixing Polyhalite with phospogypsum in a ratio of 50:50 for 1-10 minutes to yield a mixture;
Transferring said mixture to a rotating drum for 1-10 minutes to yield granules; and
Drying said granules.

6. The method of claim 5, further comprising adding add one or more inorganic materials to neutralize any acidic residues formed in the process.

7. The method of claim 6, wherein said inorganic materials is phosphate rock or Calcium carbonate.
